(19) United States
(12) Patent Application Publication
(10) Pub. No.: US 2010/0223402 A1
(43) Pub. Date: Sep. 2, 2010

(54) NETBOOK SYNCHRONIZATION CHIP DEVICE

(76) Inventor: Johnny Hsiang-Yu CHEN, Anaheim, CA (US)

Correspondence Address: Guice Patents PLLC, 12647 Galveston Court #302, Manassas, VA, 20112, US

(21) Appl. No.: 12/641,593

(22) Filed: Dec. 18, 2009

(30) Foreign Application Priority Data
Feb. 27, 2009 (TW) 098106308

(51) Int. Cl. G06F 3/00

(52) U.S. Cl. 710/8

(57) ABSTRACT

The present invention discloses a netbook synchronization chip device for data communication and power line connection between a netbook and an external device, comprising: a first USB interface, coupled to a USB host of the netbook; a second USB interface, coupled to the external device; a memory unit, used for buffering transmission data and storing an application software and a firmware, wherein the application software can be downloaded and executed by the netbook and the external device to transform a peripheral device into a USB device with an accessible root directory; and a synchronization chip controller, used for identifying the external device and performing data communication and power line connection between the netbook and the external device according to the firmware.

### BACKGROUND OF THE INVENTION

1. Field of the Invention

The present invention relates to a data synchronization device for a small-sized portable computer, and more particularly to a netbook synchronization chip device for a netbook to maintain data synchronization with an external device and obtain external charging power.

2. Description of the Related Art

To reduce the price and to increase the portability, the netbook computer usually removes some peripheral devices to feature a small form factor. However, the memory capacity and the data transmission capacity of the netbook computer are then limited. Besides, with the small form factor, the battery capacity provided inside is also limited. A netbook user, for example a salesperson who needs to bring the netbook computer outdoors for visiting clients, may need to transfer the related files to his company's computer to keep the data synchronized after he returns to his office.

Further, due to the limited battery capacity, the netbook needs to be charged from time to time. However, the general netbook, with only a limited number of peripheral devices, has limited ability to communicate with a personal computer for data synchronization; and if the charger is not available when the netbook needs to be charged, it is also irritating for the user. Therefore, there needs a low cost means for the netbook to cope with the problems of data synchronization and battery charging without increasing the form factor.

### SUMMARY OF THE INVENTION

In regard to the related problems of the netbook, the present invention proposes a solution capable of simultaneously fulfilling the requirements of data synchronization and battery charging of the netbook.

One objective of the present invention is to provide a netbook synchronization chip device, which facilitates a netbook to synchronize the data with an information processing device via USB interfaces.

Another objective of the present invention is to provide a netbook synchronization chip device, which facilitates a netbook and an information processing device to share peripheral devices of each other.

Still another objective of the present invention is to provide a netbook synchronization chip device, which facilitates a netbook to access a USB device.

Still another objective of the present invention is to provide a netbook synchronization chip device, which facilitates a netbook to obtain charging power from an information processing device.

Still another objective of the present invention is to provide a netbook synchronization chip device, comprising an application program, which can be downloaded and executed by a netbook and an information processing device to transform the data format of the hard drive to be compatible with the FAT32 format.

Still another objective of the present invention is to provide a netbook synchronization chip device, which facilitates a netbook and an information processing device to share peripheral devices of each other, and thereby the data of a memory card in a card reader of the netbook can be copied to a storage device of the information processing device, or the data of a memory card in a card reader of the information processing device can be copied to a storage device of the netbook.

To accomplish the above objectives, the present invention proposes a netbook synchronization chip device for data communication and power line connection between a netbook and an external device, comprising: a first USB interface, coupled to a USB host of the netbook; a second USB interface, coupled to the external device which can be a USB device or a device comprising a USB host; a memory unit for buffering transmission data and storing an application software and a firmware, wherein the application software can be downloaded and executed by the netbook and the external device to transform a peripheral device of the netbook or a peripheral device of the external device into a USB device with an accessible root directory, and allow the peripheral device commonly shared by the netbook and the external device via the first USB interface and the second USB interface; and a synchronization chip controller, used for identifying the external device and controlling the first USB interface and the second USB interface to perform data communication and power line connection between the netbook and the external device according to the firmware.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 is a block diagram of a netbook synchronization chip according to a preferred embodiment of the present invention.

FIG. 2 is a block diagram of a first application of a netbook synchronization chip according to a preferred embodiment of the present invention.

FIG. 3 is a block diagram of a second application of a netbook synchronization chip according to a preferred embodiment of the present invention.

### DETAILED DESCRIPTION OF THE PREFERRED EMBODIMENTS

The present invention will be described in more detail hereinafter with reference to the accompanying drawings that show the preferred embodiment of the invention.

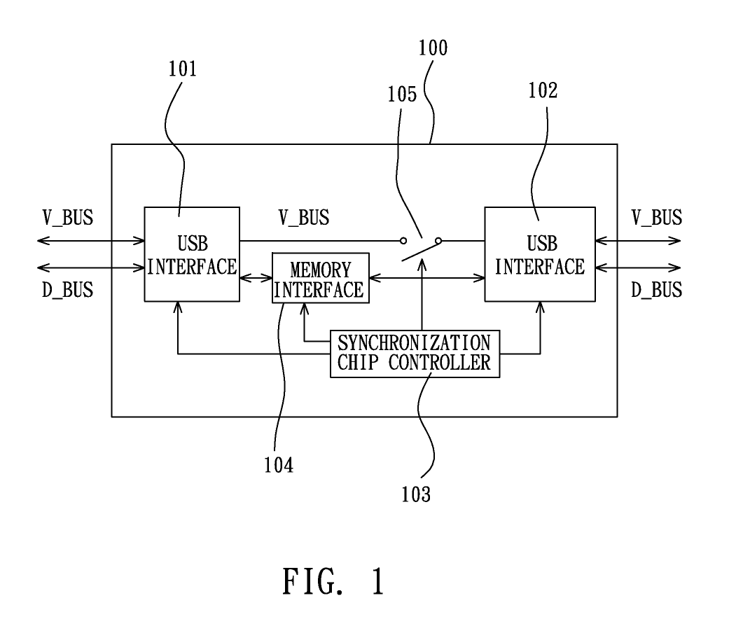

Please refer to FIG. 1, which shows a block diagram of a netbook synchronization chip according to a preferred embodiment of the present invention. As shown in FIG. 1, the netbook synchronization chip of the present invention, used for data communication or power line connection between a netbook and an external device, comprises USB interfaces 101-102, a synchronization chip controller 103, a memory unit 104 and a switch 105.

In the chip, the USB interface 101 is used for coupling to a USB host of the netbook. The USB interface 102 is used for coupling to the external device, which can be a USB device or an information processing device including a USB host. The information processing device can be, for example but not limited to, a personal computer.

The synchronization chip controller 103 can identify the external device and control the USB interfaces 101-102, the memory unit 104 and the switch 105 according to a firmware in the memory unit 104, to perform data transmission or power line connection between the netbook and the external device. When the external device is a USB device, the synchronization chip controller 103 can detect the pull-up resistance of a data line(D+ or D−) of D_BUS in the USB interface 102 (depending on the operating speed of the USB device, which can be classified into low speed, full speed and high speed) to identify the USB device. The synchronization chip controller 103 can drive the switch 105 to control the switching of a V_Bus power line. When the external device is a USB device, the synchronization chip controller 103 can drive the switch 105 to connect the V_Bus power line to the USB device to supply the operating power; when the external device is an information processing device, the synchronization chip controller 103 can connect the V_Bus power line to the netbook so that the netbook can obtain charging power from the information processing device.

The memory unit 104 is used to buffer transmission data and store an application software and a firmware, wherein the application software can be downloaded and executed by the netbook and the external device to transform peripheral devices of the netbook and of the external device into USB devices with accessible root directories, and make the peripheral devices commonly shared by the netbook and the external device via the first USB interface and the second USB interface. Besides, the application software can also be run by the netbook and the information processing device to transform the data format of the hard drive pertaining to, for example the WINDOWS operating system or the Linux operating system, to be compatible with a FAT32 format.

The switch 105 is used to determine the connection of the V_Bus power line between the USB interface 101 and the USB interface 102.

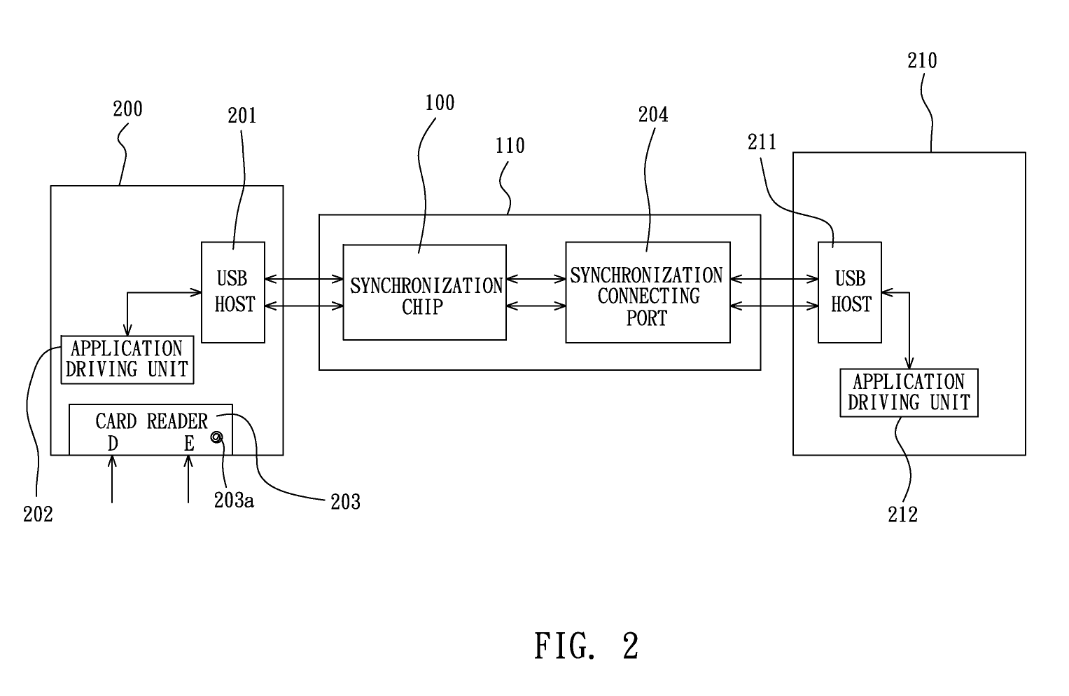

Please refer to FIG. 2, which shows a block diagram of a first application of a netbook synchronization chip according to a preferred embodiment of the present invention. As shown in FIG. 2, the first application of a netbook synchronization chip according to a preferred embodiment of the present invention comprises a synchronization chip device 110, a netbook 200 and a personal computer 210.

In the application, the synchronization chip device 110 comprises a synchronization chip 100 and a synchronization connecting port 204, wherein the synchronization connecting port 204 can be a USB type A socket for the external device to engage.

The netbook 200 comprises a USB host 201, an application driving unit 202 and a card reader 203. The USB host 201 is coupled to the USB interface 101 of the synchronization chip 100 to perform data transmission or power line connection.

The application driving unit 202 is coupled to the USB host 201 to execute the application software downloaded from the synchronization chip 100 to transform a netbook peripheral device, for example but not limited to a SATA hard drive or a graphic card, into a USB device with an accessible root directory, which can be accessed by the personal computer 210 via the synchronization chip device 110.

The card reader 203 has a fast-copy-button 203a for copying the data in a memory card, which is engaged with the card reader 203, to a storage device of the personal computer 210 through the USB host 201 and the synchronization chip device 110, under the control of the application driving unit 202. The personal computer 210 has a USB host 211 and an application driving unit 212.

The USB host 211 is coupled to the synchronization connecting port 204 of the synchronization chip device 110 to perform data transmission or power connection.

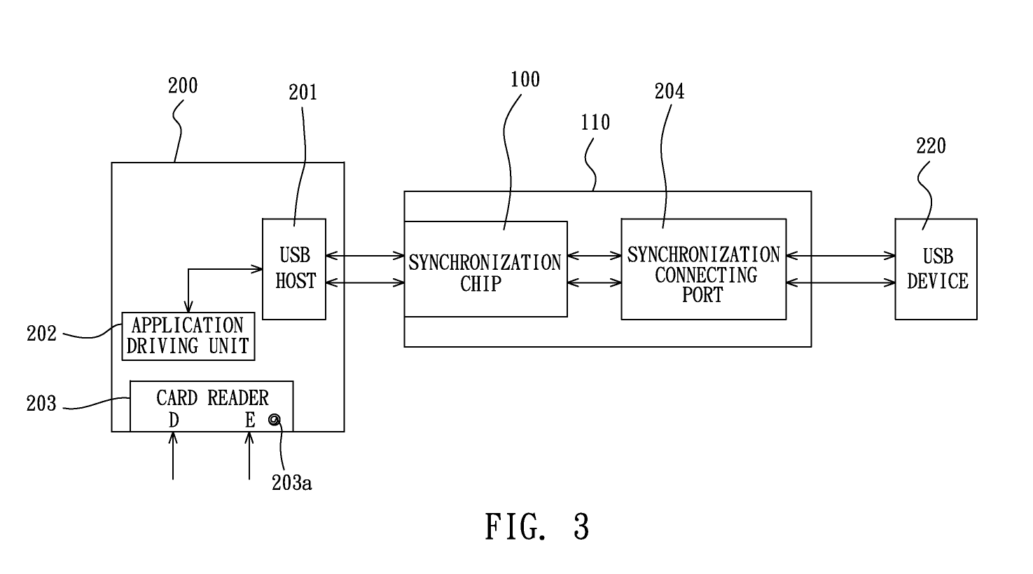

The application driving unit 212 is coupled to the USB host 211 to execute the application software downloaded from the synchronization chip 100 to transform a peripheral device of the personal computer 210, for example but not limited to a card reader, a SATA hard drive or a graphic card, into a USB device with an accessible root directory, which can be accessed by the netbook 200 via the synchronization chip device 110. Please refer to FIG. 3, which shows a block diagram of a second application of a netbook synchronization chip according to a preferred embodiment of the present invention. As shown in FIG. 3, the second application of a netbook synchronization chip according to a preferred embodiment of the present invention comprises a synchronization chip device 110, a netbook 200 and a USB device 220. In the application, the synchronization chip device 110 comprises a synchronization chip 100 and a synchronization connecting port 204, wherein the synchronization connecting port 204 can be a USB type A socket for the external device to engage.

The netbook 200 comprises a USB host 201, an application driving unit 202 and a card reader 203. The USB host 201 is coupled to the USB interface 101 of the synchronization chip 100 to perform data transmission or power line connection.

The application driving unit 202 is coupled to the USB host 201 to execute the application software downloaded from the synchronization chip 100 to transform a netbook peripheral device, for example but not limited to a SATA hard drive or a graphic card, into a USB device with an accessible root directory, which can be accessed by the personal computer 210 via the synchronization chip device 110.

The card reader 203 has a fast-copy-button 203a for copying the data in a memory card, which is engaged with the card reader 203, to the USB device 220 through the USB host 201 and the synchronization chip device 110, under the control of the application driving unit 202.

The USB device 220 is coupled to the synchronization connecting port 204 of the synchronization chip device 110 to perform data transmission or power connection.

Therefore, through the implementation of the netbook synchronization chip device of the present invention, a solution for a netbook to obtain external charging power and synchronize its data with an external device, without increasing its form factor, is provided and has indeed conquered the disadvantages of the prior art.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. A netbook synchronization chip device for data communication and power line connection between a netbook and an external device, comprising:
a first USB interface, coupled to a USB host of said netbook;
a second USB interface, coupled to said external device and comprising a USB device or a device comprising a USB host;
a memory unit coupled to said first USB interface and said second USB interface for buffering transmission data and storing an application software and a firmware, wherein said application software can be downloaded and executed by said netbook and said external device to transform a peripheral device of said netbook or a peripheral device of said external device into a USB device with an accessible root directory, and allow said peripheral device to be commonly shared by said netbook and said external device via said first USB interface and said second USB interface;
and a synchronization chip controller coupled to said first USB interface, said second USB interface, and said memory unit for identifying said external device and controlling said first USB interface and said second USB interface to perform data communication and power line connection between said netbook and said external device according to said firmware.

2. The netbook synchronization chip device as claim 1, wherein said external device is an information processing device.

3. The netbook synchronization chip device as claim 1, wherein said synchronization chip controller can identify a USB device by sensing a USB device pull-up resistance on a data line of said second USB interface.

4. The netbook synchronization chip device as claim 1, wherein said netbook comprises:
a netbook USB host coupled to said first USB interface to perform data transmission or power transmission; and
a netbook application driving unit coupled to said netbook USB host for executing said application software downloaded from said synchronization chip to transform a netbook peripheral device into a USB device with an accessible root directory.

5. The netbook synchronization chip device as claim 4, wherein said netbook peripheral device is a card reader having a fast-copy-button.

6. The netbook synchronization chip device as claim 4, wherein said netbook peripheral device is a SATA hard drive, of which the data format can be transformed to be compatible with a FAT32 format under the control of said netbook application driving unit.

7. The netbook synchronization chip device as claim 4, wherein said netbook peripheral device is a graphic card.

8. The netbook synchronization chip device as claim 2, wherein said information processing device comprises:
an information processing device USB host coupled to said second USB interface to perform data transmission or power transmission; and
an information processing device application driving unit coupled to said information processing device USB host for executing said application software downloaded from said synchronization chip to transform a peripheral device of said information processing device into a USB device with an accessible root directory.

9. The netbook synchronization chip device as claim 8, wherein said peripheral device of said information processing device is a SATA hard drive, of which the data format can be transformed to be compatible with a FAT32 format under the control of said information processing device application driving unit.

10. The netbook synchronization chip device as claim 8, wherein said peripheral device of said information processing device is a graphic card.

11. The netbook synchronization chip device as claim 2, wherein said netbook can be charged by coupling to said information processing device via said netbook synchronization chip.

12. The netbook synchronization chip device as claim 1, wherein said external device is a USB device, which can be charged by coupling to said netbook USB host via said netbook synchronization chip.

13. The netbook synchronization chip device as claim 1, further comprising a synchronization connecting port, which is coupled to said second USB interface, and has a type A USB socket for said external device to engage.
